(19) United States
(12) Patent Application Publication
(10) Pub. No.: US 2026/0252532 A1
(43) Pub. Date: Aug. 27, 2026

(54) METHODS AND SYSTEMS FOR DEDUPLICATING RECORDS

(71) Applicant: SHOPIFY INC., Ottawa (CA)

(72) Inventors: Christophe NAUD-DULUDE, Montreal (CA); Anshudeep MATHUR, Kitchener (CA); Katharine RAGOTTE, East York (CA); Cody MAZZA-ANTHONY, Toronto (CA); Kshetrajna Raghavan, Fremond, CA (US); Peng YU, Montreal (CA); Julio Cesar de ALMEIDA MAIA, St. Petersburg, FL (US); Audrey-Anne GUINDON, Montreal (CA); Jonathan OHAYON, Lyon (FR); Derek PYNE, Toronto (CA); Javier Arturo MORENO CAMARGO, Toronto (CA)

(21) Appl. No.: 19/179,361

(22) Filed: Apr. 15, 2025

Related U.S. Application Data
(60) Provisional application No. 63/761,374, filed on Feb. 21, 2025.

(51) Int. Cl. G06F 16/174; G06F 16/3329; G06F 16/35; G06F 16/901

(52) U.S. Cl. CPC G06F 16/1748; G06F 16/33295; G06F 16/35; G06F 16/9024

(57) ABSTRACT

Methods and systems for the automatic deduplication of a set of data records corresponding to a plurality of unique items are described. An automated engine generates corresponding metadata for each data record in the set of data records. A graph network is generated based on the set of data records, including the generated metadata, where the graph network comprises a plurality of nodes and a plurality of edges connecting the nodes, each node corresponding to a respective data record of the set of data records and each edge representing a relationship between two associated nodes. A subset of nodes in the graph network is assigned to a respective item of the plurality of unique items and verified using an LLM. The graph network is updated, based on the verification. The disclosed methods and systems enable the effective deduplication of data records in a computationally efficient manner.

### CROSS REFERENCE TO RELATED APPLICATION

This application claims priority from U.S. Provisional Application No. 63/761,374, filed Feb. 21, 2025, entitled METHODS AND SYSTEMS FOR DEDUPLICATING RECORDS, the contents of which are incorporated by reference into the Detailed Description herein below in their entirety.

### FIELD

The present disclosure relates to machine learning and large language models (LLMs), and, more particularly, to systems for processing data records using a graph network, and, yet more particularly, to methods and systems for deduplicating records using a graph network.

### BACKGROUND

A large language model (LLM) is a type of machine learning (ML) model that can process natural language to summarize, translate, predict and generate text and other content. A LLM may be trained to learn billions of parameters in order to model how words relate to each other in a textual sequence. Inputs to an LLM may be referred to as prompts. A prompt is a natural language input that includes instructions to cause the LLM to generate a desired output, including natural language text or other generative output in various desired formats.

### SUMMARY

Data records (e.g., stored in a database) may be created by one or more sources and may include structured and unstructured information. During the creation of a data record, a data management system may enforce the provision of an identifier that identifies the data record according to an established taxonomy (e.g., for the purpose of distinguishing the data record from other records, or for effectively linking the data record to a unique item of a plurality of unique items, among other possibilities), or the data management system or platform may not enforce the provision of an identifier to data records. In some embodiments, for example, a universal identifier (UID) may be associated with a data record during the creation of the data record. An example of a UID includes an International Standard Book Number (ISBN), which represents a 13-digit number that is uniquely assigned to each specific edition of a book (e.g., for specifying the book format, edition, publisher, etc.), however it is understood that other formats for UIDs may be used.

The provision of a UID to a data record can be cumbersome and computationally inefficient, for example, adding extra steps to search for an appropriate UID and populate a correct field with the UID, etc. Furthermore, the provision of UIDs is not immune to errors. For example, incorrect UIDs may be provisioned to data records or separate UIDs may be erroneously generated for the same item, thereby undermining the purpose of assigning a UID in the first place. However, without the provision of a UID to each data record, the data management system may not recognize data records representative of the same item (e.g., that may have been created independently by different sources, or by the same source but at different times, etc.). In this regard, a search engine having access to the datastore may return multiple search results for the same item, reducing the diversity of search results, unnecessarily consuming processing resources to render duplicate results and contributing to a poor user experience.

Furthermore, given that data records in the datastore can include unstructured data, not all fields in each data record may be populated (e.g., the data may be sparse) nor will the information included in each field have equal importance in determining whether data records are representative of the same item.

One potential solution is to use a large language model (LLM) to detect duplicate records (e.g., data records that represent the same item). For example, a LLM may be provided with a prompt to instruct the LLM to label each data record in a set of data records based on a pre-determined list of item labels, or the LLM may be instructed to compare data records from the datastore in a pairwise manner to determine whether the data records represent the same item. In examples, pairwise comparison approach can be performed for every pair of records in the datastore, to accurately detect duplicate records. For example, a pairwise comparison may involve the calculation of a cross product of the pair of inputs, which can be very large. Furthermore, it is understood that LLMs are computationally intensive, in part due to the size of LLMs (particularly their large number of model parameters and how these parameters are used). In this regard, using an LLM to identify duplicate data records in a pairwise approach consumes extensive computing resources (e.g., memory, processing power, computing time), particularly for a large datastore of data records, such as a large graph database. Furthermore, this approach is not scalable, for example, requiring considerable processing resources each time a new data record is added to the datastore (e.g., to instruct the LLM to compare the new data record in a pairwise manner with each data record in the datastore to detect whether the new data record represents an existing item or a new item). Additionally, depending on the size of the datastore (e.g., the size of the database to be processed), LLMs can be costly to operate in terms of cost per token.

In various examples, the present disclosure provides a technical solution for processing data records that addresses at least some of the above drawbacks. More specifically, the present disclosure describes methods and systems for automatically deduplicating a set of data records corresponding to a plurality of unique items, using a generated graph network. An automated engine extracts and/or generates corresponding metadata (e.g., as attributes) for each data record in the set of data records. In examples, the graph network is generated based on the set of data records, including the generated metadata, where the graph network comprises a plurality of nodes and a plurality of edges connecting the nodes, each node in the graph network corresponding to a respective data record of the set of data records and each edge in the graph network representing a relationship between two associated nodes. The graph network may be processed (e.g., using a clustering algorithm) and a subset of nodes in the graph network is assigned to a respective item of the plurality of unique items, based on the processing. The assignment may be verified using an LLM, for example, the LLM may receive a prompt instructing the LLM to determine whether pairs of data records within the same subset of data records are assigned correct identifiers and represent the same item, or whether pairs of data records do not represent the same item. The graph network is updated, based on the verification, for example, links between nodes may be modified, fields associated with the data records may be populated or modified, or data records may be removed from the datastore, or merged with other records, based on the verification. The disclosed methods and systems enable the effective deduplication of data records in a computationally efficient manner.

The disclosed solution automatically deduplicates data records corresponding to a plurality of items across multiple categories. Advantageously, the technical solution generates a graph network for a large datastore (e.g., representing a large number of data records corresponding to a plurality of items across various categories), and accurately and effectively groups data records at an “item level”, without requiring the provision of a UID to each data record at the time of record creation. A technical benefit is provided in that data records having uncategorized data or unstructured data may still be effectively assigned to a respective item, given that the proposed approach leverages the use of probabilistic matches for nodes in the graph network, and/or that certain attributes may be weighted for use in clustering algorithms, depending on an item category.

The disclosed solution provides the technical effect that computationally efficient approaches (e.g., vector similarity search, clustering algorithms etc.) are employed for linking data records to generate the graph network. The technical solution may benefit from the strategic use of an LLM for verifying the accuracy of linked data records in the graph network, thereby effectively reducing the computing resources (e.g., processing power, memory, computing time, etc.) that would otherwise be required if the LLM were used to identify duplicate records during graph network generation.

Examples of the proposed record deduplication system may improve the performance of user interfaces (UIs) by automatically adjusting graphical elements within the UI to optimize the available UI space and enable the presentation of more unique results. Advantageously, when used in cooperation with a search engine, the disclosed solution avoids the unnecessary use of processing power to render duplicate search results in a UI. For example, an output including a condensed result set (e.g., including multiple results associated with the same unique item configured under the same region of the UI, for example, within a single selectable and/or expandable UI element) may be automatically provided to the user within a UI, for example, in a manner that makes it easier for the user to engage with a more diverse result set. Similarly, a condensed result set may be processed by the system such that the selectable and/or expandable GUI element is automatically positioned within the GUI in a condensed configuration, thereby avoiding the unnecessary use of processing power to render duplicate results associated with the same unique item. In this regard, restricting the display of search results for identical items (e.g., by collapsing groups of search results into a single UI element) improves user browsing experience by presenting search results that are distinct, diverse and more appealing to the user, while optimizing computational resources.

In some examples, the present disclosure describes a computer-implemented method. The method includes a number of steps, including: generating a graph network based on a set of data records corresponding to a plurality of unique items, the graph network comprising a plurality of nodes and a plurality of edges connecting the nodes, wherein each node in the graph network corresponds to a respective data record of the set of data records and each edge in the graph network represents a relationship between two associated nodes, the nodes being connected by the edge; assigning one or more subsets of nodes in the graph network to a respective item of the plurality of unique items; verifying, using a large language model (LLM), that the one or more subsets of nodes are correctly assigned to the respective item of the plurality of unique items; and updating the graph network based on the verification.

In an example of the preceding example aspect of the method, wherein assigning the one or more subsets of nodes in the graph network to the respective item comprises: clustering the nodes in the graph network, using a clustering algorithm, to generate the one or more subsets of nodes; and annotating the one or more subsets of nodes with an associated item identifier.

In an example of a preceding example aspect of the method, further comprising: processing the set of data records to generate a set of processed data records including corresponding metadata; and generating the graph network based on the set of processed data records.

In an example of the preceding example aspect of the method, wherein each data record in the set of data records is associated with a respective category, and processing the set of data records comprises: for each data record in the set of data records: generating the metadata as one or more attributes, based on the respective category; and appending the one or more attributes to the data record to generate a processed data record.

In an example of the preceding example aspect of the method, wherein the one or more attributes are synthetic attributes generated using a multi-modal LLM.

In an example of a preceding example aspect of the method, wherein the data record includes an image, and the one or more attributes are generated based on the image.

In an example of a preceding example aspect of the method, wherein generating the graph network comprises: linking one or more data records in the set of data records, based on a determined relationship between the one or more data records indicating that the one or more data records are likely to represent the same or similar item of the plurality of unique items.

In an example of the preceding example aspect of the method, wherein the determined relationship is based on a deterministic matching of attributes in the processed data records.

In an example of a preceding example aspect of the method, wherein the determined relationship is based on a probabilistic likelihood that the linked data records represent the same item of the plurality of unique items.

In an example of a preceding example aspect of the method, wherein generating the graph network comprises: applying an embedding transformation to one or more data records in the set of data records, to generate one or more data record embeddings; and linking at least two of the data records, based on a similarity measure between corresponding at least two of the data record embeddings; wherein each node corresponds to a respective data record of the linked data records and each edge corresponds to a respective relationship between two of the linked data records.

In an example of a preceding example aspect of the method, wherein verifying that the one or more subsets of nodes are correctly associated with the respective item comprises: generating a prompt to the LLM for comparing a pair of nodes of the one or more subsets of nodes, the prompt including attributes and/or images associated with the pair of nodes and instructions to determine whether the pair of nodes represent the same item; and providing the prompt to the LLM to generate a response indicating whether the pair of nodes represent the same item.

In an example of a preceding example aspect of the method, wherein updating the graph network comprises: modifying at least one node in the graph network, based on a determination of whether the at least one node is correctly assigned to the respective item of the plurality of unique items.

In an example of the preceding example aspect of the method, wherein the at least one node is associated with a first subset of the one or more subsets of nodes in the graph network, and modifying the at least one node comprises one of: merging the at least one node with another node in the first subset of nodes; updating the at least one node to include information common to other nodes in the first subset of nodes; removing the at least one node from the first subset of nodes; or adding the at least one node to a second subset of nodes that is different from the first subset of nodes.

In an example of a preceding example aspect of the method, further comprising: responsive to a search query, transmitting a signal to cause a display of a remote user device to output a user interface (UI) having a plurality of returned search results corresponding to the plurality of unique items, based on the updated graph network.

In some examples, the present disclosure describes a computer system including: a processing unit configured to execute computer-readable instructions to cause the system to: generate a graph network based on a set of data records corresponding to a plurality of unique items, the graph network comprising a plurality of nodes and a plurality of edges connecting the nodes, wherein each node in the graph network corresponds to a respective data record of the set of data records and each edge in the graph network represents a relationship between two associated nodes, the nodes being connected by the edge; assign one or more subsets of nodes in the graph network to a respective item of the plurality of unique items; verify, using a large language model (LLM), that the one or more subsets of nodes are correctly assigned to the respective item of the plurality of unique items; and update the graph network based on the verification.

In an example of the preceding example aspect of the system, wherein in assigning the one or more subsets of nodes in the graph network to the respective item, the processing unit is further configured to execute computer-readable instructions to cause the computer system to: cluster the nodes in the graph network, using a clustering algorithm, to generate the one or more subsets of nodes; and annotate the one or more subsets of nodes with an associated item identifier.

In an example of a preceding example aspect of the system, wherein the processing unit is further configured to execute computer-readable instructions to cause the computer system to: process the set of data records to generate a set of processed data records including corresponding metadata; and generate the graph network based on the set of processed data records.

In an example of the preceding example aspect of the system, wherein each data record in the set of data records is associated with a respective category, and wherein in processing the set of data records, the processing unit is further configured to execute computer-readable instructions to cause the computer system to: for each data record in the set of data records: generate the metadata as one or more attributes, based on the respective category; and append the one or more attributes to the data record to generate a processed data record.

In an example of the preceding example aspect of the system, wherein the one or more attributes are synthetic attributes generated using a multi-modal LLM.

In an example of a preceding example aspect of the system, wherein the data record includes an image, and the one or more attributes are generated based on the image.

In an example of a preceding example aspect of the system, wherein in generating the graph network, the processing unit is further configured to execute computer-readable instructions to cause the computer system to: link one or more data records in the set of data records, based on a determined relationship between the one or more data records indicating that the one or more data records are likely to represent the same or similar item of the plurality of unique items.

In an example of the preceding example aspect of the system, wherein the determined relationship is based on a deterministic matching of attributes in the processed data records.

In an example of a preceding example aspect of the system, wherein the determined relationship is based on a probabilistic likelihood that the linked data records represent the same item of the plurality of unique items.

In an example of a preceding example aspect of the system, wherein in generating the graph network, the processing unit is further configured to execute computer-readable instructions to cause the computer system to: apply an embedding transformation to one or more data records in the set of data records, to generate one or more data record embeddings; and link at least two of the data records, based on a similarity measure between corresponding at least two of the data record embeddings; wherein each node corresponds to a respective data record of the linked data records and each edge corresponds to a respective relationship between two of the linked data records.

In an example of a preceding example aspect of the system, wherein in verifying that the one or more subsets of nodes are correctly associated with the respective item, the processing unit is further configured to execute computer-readable instructions to cause the computer system to: generate a prompt to the LLM for comparing a pair of nodes of the one or more subsets of nodes, the prompt including attributes and/or images associated with the pair of nodes and instructions to determine whether the pair of nodes represent the same item; and provide the prompt to the LLM to generate a response indicating whether the pair of nodes represent the same item.

In an example of a preceding example aspect of the system, wherein in updating the graph network, the processing unit is further configured to execute computer-readable instructions to cause the computer system to: modify at least one node in the graph network, based on a determination of whether the at least one node is correctly assigned to the respective item of the plurality of unique items.

In an example of the preceding example aspect of the system, wherein the at least one node is associated with a first subset of the one or more subsets of nodes in the graph network, and wherein in modifying the at least one node, the processing unit is further configured to execute computer-readable instructions to cause the computer system to perform one of: merging the at least one node with another node in the first subset of nodes; updating the at least one node to include information common to other nodes in the first subset of nodes; removing the at least one node from the first subset of nodes; or adding the at least one node to a second subset of nodes that is different from the first subset of nodes.

In an example of a preceding example aspect of the system, wherein the processing unit is further configured to execute computer-readable instructions to cause the computer system to: responsive to a search query, transmit a signal to cause a display of a remote user device to output a UI having a plurality of returned search results corresponding to the plurality of unique items, based on the updated graph network.

In some examples, the present disclosure describes a non-transitory computer-readable medium storing instructions that, when executed by a processing unit of a computing system, cause the computing system to: generate a graph network based on a set of data records corresponding to a plurality of unique items, the graph network comprising a plurality of nodes and a plurality of edges connecting the nodes, wherein each node in the graph network corresponds to a respective data record of the set of data records and each edge in the graph network represents a relationship between two associated nodes, the nodes being connected by the edge; assign one or more subsets of nodes in the graph network to a respective item of the plurality of unique items; verify, using a large language model (LLM), that the one or more subsets of nodes are correctly assigned to the respective item of the plurality of unique items; and update the graph network based on the verification.

In some examples, the computer-readable medium may store instructions that, when executed by the processor of the computing system, cause the computing system to perform any of the methods described above.

### BRIEF DESCRIPTION OF THE DRAWINGS

Reference will now be made, by way of example, to the accompanying drawings which show example embodiments of the present application, and in which:

FIG. 1A is a block diagram of a simplified convolutional neural network, which may be used in examples of the present disclosure;

FIG. 1B is a block diagram of a simplified transformer neural network, which may be used in examples of the present disclosure;

FIG. 2A is a block diagram illustrating an exemplary simplified system in which exemplary embodiments of the present disclosure may be implemented;

FIG. 2B is a block diagram of an example computing system, which may be used to implement examples of the present disclosure;

FIG. 3 is a block diagram illustrating an example record deduplication system, in accordance with example embodiments of the present disclosure;

FIG. 4 is a block diagram illustrating an example graph network engine, in accordance with example embodiments of the present disclosure;

FIG. 5A is a simplified schematic diagram of an example graph network, in accordance with example embodiments of the present disclosure;

FIG. 5B is a simplified schematic diagram of an example clustered graph network, in accordance with example embodiments of the present disclosure;

FIG. 6 is an example of a simplified graphical user interface (GUI), in accordance with example embodiments of the present disclosure; and

FIG. 7 is a flowchart illustrating an example method for deduplicating data records, in accordance with examples of the present disclosure.

Similar reference numerals may have been used in different figures to denote similar components.

### DETAILED DESCRIPTION

In various examples, methods and systems for the automatic deduplication of a set of data records corresponding to a plurality of unique items are described. An automated engine generates corresponding metadata for each data record in the set of data records. A graph network is generated based on the set of data records, including the generated metadata, where the graph network comprises a plurality of nodes and a plurality of edges connecting the nodes, each node corresponding to a respective data record of the set of data records and each edge representing a relationship between two associated nodes. A subset of nodes in the graph network is assigned to a respective item of the plurality of unique items and verified using an LLM. The graph network is updated, based on the verification. The disclosed methods and systems enable the effective deduplication of data records in a computationally efficient manner.

Examples of the disclosed solution employ computationally efficient approaches (e.g., vector similarity search, clustering algorithms etc.) for linking data records in a graph network and strategically use LLMs for verifying the accuracy of linked data records in the graph network (rather than for constructing the graph network). This provides a technical advantage in that the overall use of computing resources (e.g., processing power, memory, computing time, etc.) that would otherwise be required (e.g., if the LLM were used to identify duplicate records during graph network generation) is effectively reduced.

Examples of the disclosed record deduplication system may improve the performance of UIs by automatically adjusting graphical elements within the UI according to a need of the user or the system. Examples of the disclosed technical solution output a condensed result set within a single selectable and/or expandable UI element, to optimize the available UI space and enable the presentation of more unique search results in a computationally efficient manner.

As will be discussed further below, examples of the disclosed record deduplication system may send prompts to and receive output from an LLM, which is a type of deep neural network.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

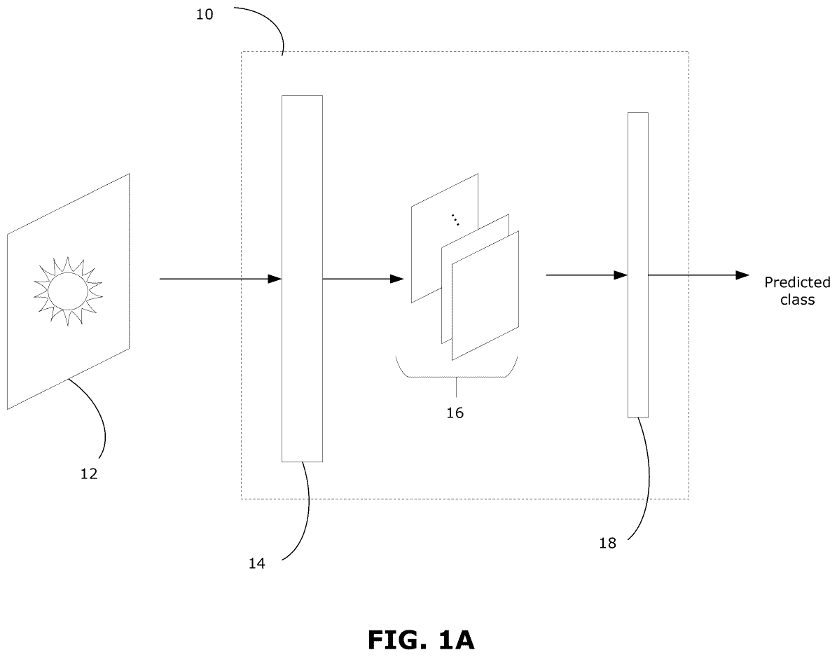

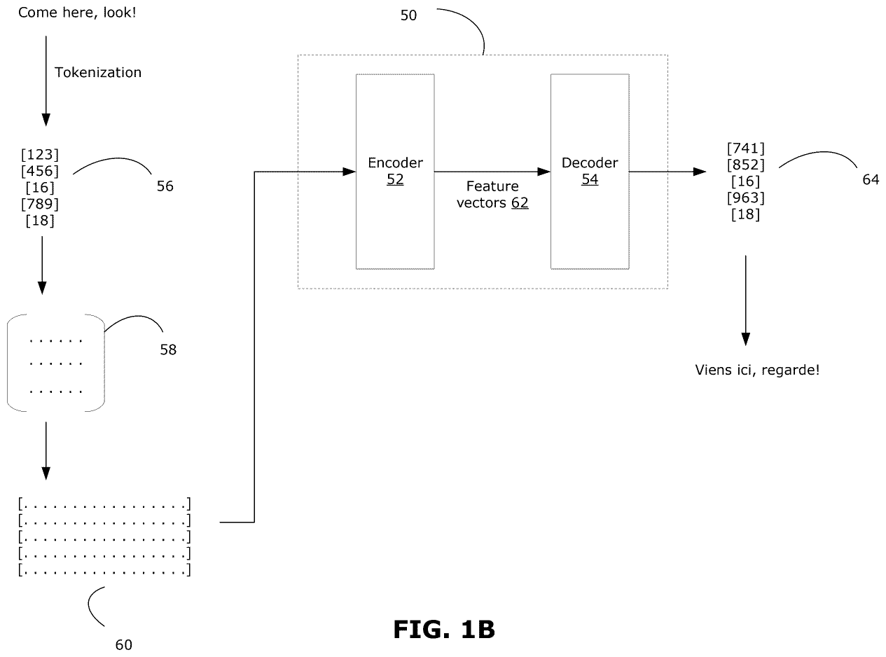

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labeled (e.g., annotated to indicate verbs, nouns, etc.) or unlabeled. LLMs may be trained on a large unlabeled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some preprocessing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space (or embedding space) may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT- 3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

Although described above in the context of language tokens, embeddings and feature vectors are also commonly used to encode information about objects and their relationships with each other. For example, embeddings and feature vectors are frequently used in computer vision applications for object detection and semantic understanding. Embeddings that represent objects may be found in an embedding space, where the similarity and relationship of two objects (e.g., similarity between a cat and a lion) may be represented by the distance between the two corresponding embeddings in the embedding space.

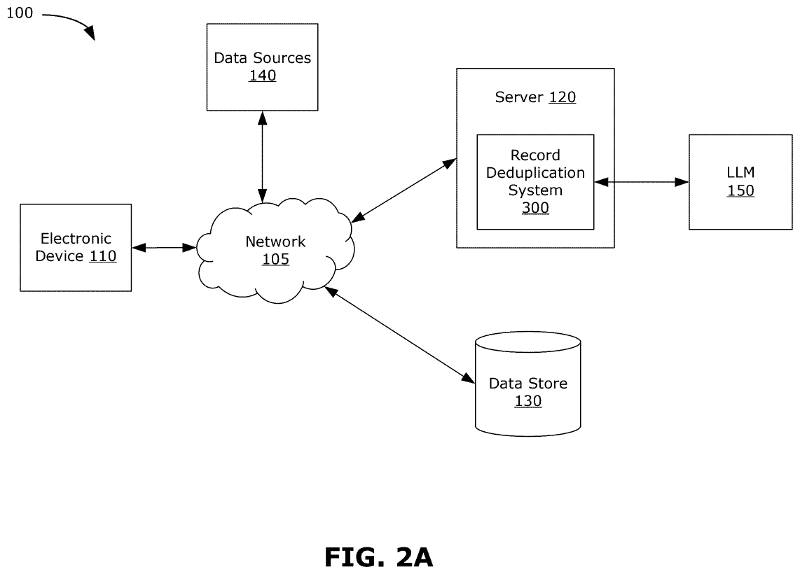

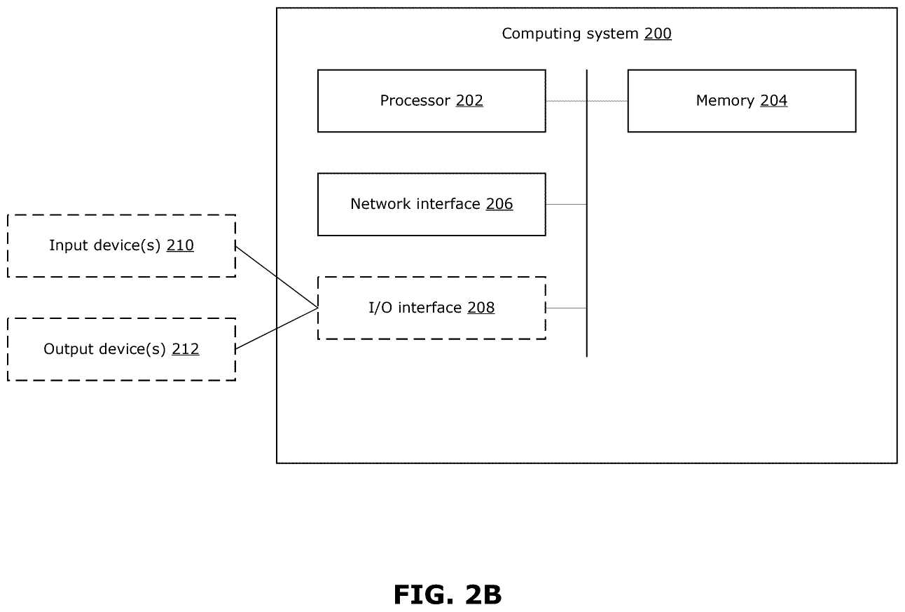

FIG. 2A is a block diagram illustrating an exemplary simplified system 100 in which exemplary embodiments of the present disclosure may be implemented. The system 100 has been simplified in this example for ease of understanding. Generally, there may be more entities and components in the system 100 than that shown in FIG. 2A. The system 100 may be an integrated system for requesting data from a database. The system 100 may include a data communications network 105. The data communications network 105 may be any form of data communications network (e.g., an intranet, the Internet, a P2P network, a WAN and/or a LAN, among other possibilities). The system 100 may further include one or more electronic devices 110, a server 120, a data store 130 and one or more data sources 140 and may cooperate with a large language model (LLM) 150. Although the server 120 and the data store 130 are shown as separate components, it is understood that the server 120 and the data store 130 could be embodied in a single component, such as a cloud environment, among other possibilities. Similarly, although the server 120 and the LLM 150 are shown as separate components, it is understood that the server 120 and the LLM 150 could be embodied in a single component.

In examples, a user may interact with the system 100 via the electronic device 110, for example, using a client application (e.g., a web browser, a search engine, or another application). In examples, the electronic device 110 may connect to the network 105 in order to communicate with the server 120 to request access to a service provided by a server 120 and to cause the electronic device 110 to provide an output, as described herein. The electronic device 110 may be associated with a display (not shown), for example, for providing output to a user on the display. In examples, the electronic device 110 can be a desktop computer, a laptop computer, a mobile communication device (such as a smart phone or a tablet), a wearable device (such as a smart watch or VR headset), or any other suitable computing device that can perform the functionality described herein.

The term “server”, as used herein, is not intended to be limited to a single hardware device. For example, the server 120 may include a server device, a distributed computing system, a virtual machine running on an infrastructure of a datacenter, or infrastructure (e.g., virtual machines) provided as a service by a cloud service provider, among other possibilities. Generally, the server 120 may be implemented using any suitable combination of hardware and software, and may be embodied as a single physical apparatus (e.g., a server device) or as a plurality of physical apparatuses (e.g., multiple machines sharing pooled resources such as in the case of a cloud service provider). The term “resources”, as used herein, can refer to hardware or software elements, for example, physical hardware infrastructure or virtual infrastructure. By way of example, resource capacity may be expressed in terms of processing power or bandwidth, memory, storage space, computing time, etc.

In examples, the server 120 may be a data server and may facilitate the execution of one or more queries for requesting data (e.g., data records) from the data store 130. In examples, the data store 130 may be a database or a distributed storage or data repository, for example, a cloud-based storage or data repository. In examples, the data store 130 may store large volumes of data (e.g., current or historical data), for example, stored in a relational database management system (RDBMS), such as an SQL server, among other possibilities, for example, providing unique data relationships through schemas and tables. In examples, the data store 130 may store data records obtained from (or generated by) one or more data sources 140.

FIG. 2B illustrates an example computing system 200, which may be used to implement examples of the present disclosure. For example, the computing system 200 may be used to implement processes of the record deduplication system 300, as disclosed herein, such as performed by the server 120 in FIG. 2A. In addition, the computing system 200 may be the electronic device 110, the data store 130, or one or more of the data sources 140. Similarly, the computing system 200 may be used to generate a prompt to the LLM 150 to cause the LLM 150 to generate output that includes text in a token-efficient language as disclosed herein. Additionally or alternatively, one or more instances of the example computing system 200 may be employed to execute the LLM 150. For example, a plurality of instances of the example computing system 200 may cooperate to provide output using an LLM 150 in manners as discussed above.

The example computing system 200 includes at least one processing unit and at least one physical memory 204. The processing unit may be a hardware processor 202 (simply referred to as processor 202). The processor 202 may be, for example, a central processing unit (CPU), a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, to the computing system 200 to carry out examples of the methods, functionalities, systems and modules disclosed herein.

The computing system 200 may also include at least one network interface 206 for wired and/or wireless communications with an external system and/or network (e.g., an intranet, the Internet, a P2P network, a WAN and/or a LAN). A network interface may enable the computing system 200 to carry out communications (e.g., wireless communications) with systems external to the computing system 200, such as a LLM residing on a remote system.

The computing system 200 may optionally include at least one input/output (I/O) interface 208, which may interface with optional input device(s) 210 and/or optional output device(s) 212. Input device(s) 210 may include, for example, buttons, a microphone, a touchscreen, a keyboard, etc. Output device(s) 212 may include, for example, a display, a speaker, etc. In this example, optional input device(s) 210 and optional output device(s) 212 are shown external to the computing system 200. In other examples, one or more of the input device(s) 210 and/or output device(s) 212 may be an internal component of the computing system 200.

A computing system, such as the computing system 200 of FIG. 2B, may access a remote system (e.g., a cloud-based system) to communicate with a remote language model or LLM (e.g., LLM 150) hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, in a message (e.g., in a payload of a message).

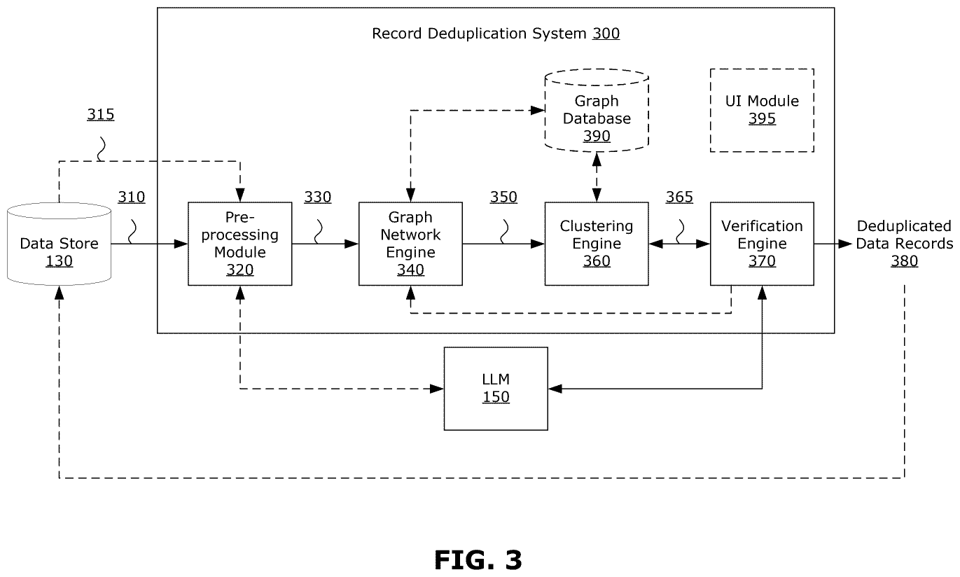

In the example of FIG. 2B, the computing system 200 may store in the memory 204 computer-executable instructions, which may be executed by a processing unit such as the processor 202, to implement one or more embodiments disclosed herein. For example, the memory 204 may store instructions for executing the record deduplication system 300, for example, described with respect to FIG. 3 below.

In some examples, the computing system 200 may be a server of an online platform that provides the record deduplication system 300 as a web-based or cloud-based service that may be accessible by a user device (e.g., via communications over a wireless network). Other such variations may be possible without departing from the subject matter of the present application.

The computing system 200 may also include a storage unit (not shown), which may include a mass storage unit such as a solid state drive, a hard disk drive, a magnetic disk drive and/or an optical disk drive. The storage unit 214 may store data, for example, a graph database 390 or an embeddings database 446, among other data. In some examples, the storage unit 214 may serve as a database accessible by other components of the computing system 200. In some examples, the graph database 390 and/or the embeddings database 446 may be external to the computing system 200, for example the computing system 200 may communicate with an external system to access the graph database 390 and/or the embeddings database 446.

As will be discussed further below, the present disclosure describes an example record deduplication system 300 that enables detection of records in a data store that represent the same item, entity or object, such that updating the data store causes the removal, merging or modification of the detected duplicate records.

FIG. 3 shows a block diagram of an example architecture for the record deduplication system 300, in accordance with examples of the present disclosure. The record deduplication system 300 may be a software that is implemented in the computing system 200 of FIG. 2B, in which the processor 202 is configured to execute instructions of the record deduplication system 300 stored in the memory 204. In examples, the record deduplication system 300 includes a pre-processing module 320, a graph network engine 340, a clustering engine 360 and a verification engine 370 and may optionally cooperate with a graph database 390 and a UI module 395. The record deduplication system 300 may receive a set of data records 310 corresponding to a plurality of unique items, as input (for example, obtained from data store 130, among other possibilities) and may output a set of deduplicated data records 380.

In examples, the pre-processing module 320 may process the set of data records 310 to generate a set of processed data records 330. In examples, each processed data record in the set of processed data records 330 may include corresponding metadata, such as structured metadata or attributes. For example, the pre-processing module 320 may perform a data cleaning process (e.g., to detect and fix errors or inconsistencies in the data records or in the corresponding metadata for each data record, among other possibilities), or the pre-processing module 320 may perform a data enriching and/or a data augmentation process, for example, by obtaining and/or generating corresponding metadata for each data record in the set of data records 310, among other possibilities. In some embodiments, for example, the corresponding metadata may represent one or more attributes. In examples, attributes may include (or be derived from) originating attributes 332 (e.g. fields that were manually or automatically populated when the data record was originally created), hierarchical attributes 334 (e.g., attributes inherited from a parent record) or synthetic attributes 336 (e.g., generated or otherwise extracted from information associated with the data record), among other possibilities.

In some examples, each data record in the set of data records 310 may be associated with a respective category (e.g., data record category 315), and the corresponding metadata generated for each data record may be tailored to the respective data record category 315 (or configured based on the respective data record category 315, among other possibilities). For example, data records associated with a category of “apparel” may have different attribute fields to populate (e.g., size, style, material etc.) compared to data records associated with vehicles (e.g., model, year, number of doors, drive train etc.). However, there may be some attributes that are universal across data records (e.g., not dependent on the record category), such as title, description, image, brand or manufacturer, etc.). In other examples, certain fields of a data record may represent attributes of greater importance for the data record, for example, depending on the category. For example, an attribute related to the year of manufacture may be a more important attribute for data records in the categories of “vehicles” or “wine” than in the category of “apparel”, among other possibilities.

In some embodiments, for example, for each data record of the set of data records 310, the pre-processing module 320 may optionally obtain the corresponding data record category 315 and may generate the corresponding metadata as synthetic metadata, based on the respective data record category 315. For example, the pre-processing module may cooperate with the LLM 150 to generate the synthetic metadata associated with each data record in the set of data records 310. For example, the pre-processing module 320 may include a prompt generator (not shown) for generating a prompt to the LLM 150, or a prompt generator external to the record deduplication system 300 may be utilized, among other possibilities. In examples, the prompt may be provided to the LLM 150 to generate an attribute (such as a simplified item title or a simplified item description, among other possibilities) based on the data record category 315, or based on other information contained in the data record. In some embodiments, for example, the LLM 150 may be a multi-modal LLM (e.g., LLaVA, BLIP-2, CLIP, GPT-4V, etc.), and the one or more attributes may be synthetic attributes 336 generated using the multi-modal LLM. In other embodiments, for example, each data record in the set of data records 310 may include an image, and the one or more attributes may be features extracted from the image (or other information associated with the data record). For example, the LLM 150 may be a multi-modal LLM (or another multi-classifier ML model) that has been trained to generate labels for an image, and the one or more attributes may include attribute labels generated by the LLM 150, based on the image, among other possibilities.

In examples, responsive to generating the one or more attributes, for each data record in the set of data records 310, the pre-processing module 320 may append the one or more attributes to the data record to generate a respective processed data record of a set of processed data records 330. In some embodiments, for example, set of processed data records 330 may be stored in the data store 130, or the set of data records 310 stored in the data store may be updated based on the set of processed data records 330, among other possibilities.

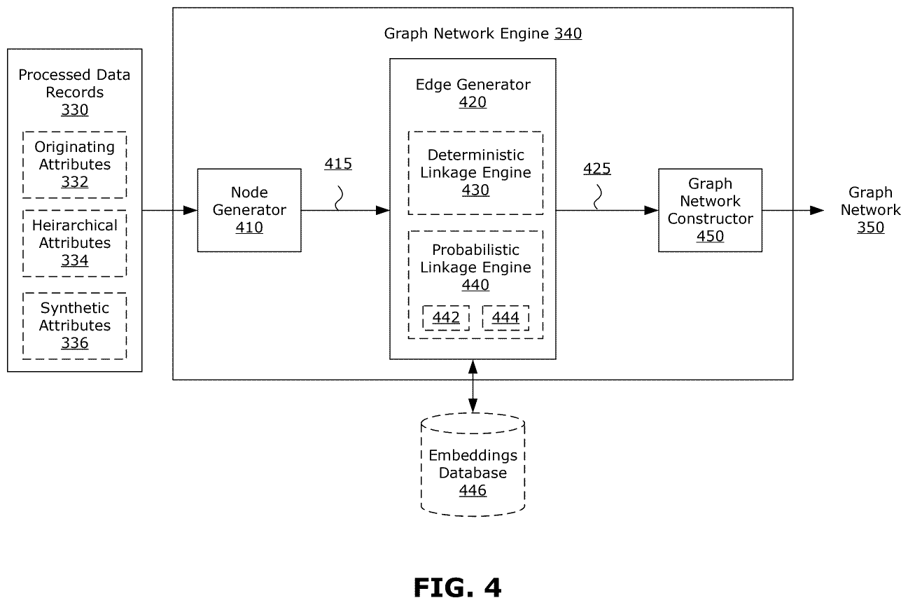

In examples, the set of processed data records 330 may be provided to the graph network engine 340 for generating a graph network 350, as described with reference to FIG. 4 below. In examples, the graph network 350 comprises a plurality of nodes and a plurality of edges connecting the nodes, wherein each node in the graph network corresponds to a respective data record of the set of data records 310 (e.g., each processed data record in the set of processed data records 330 may be mapped to a respective node of a plurality of nodes in the graph network 350) and each edge in the graph network 350 represents a relationship between two associated nodes, for example, where the nodes are connected by the edge. In this way, the set of processed data records 330 (and by extension, the set of data records 310) may be linked (e.g., as nodes connected by edges) in the graph network 350, according to the relationships between each data record.

FIG. 4 shows a block diagram of an example architecture for the graph network engine 340, in accordance with examples of the present disclosure. The graph network engine 340 may be a software that is implemented in the computing system 200 of FIG. 2B, in which the processor 202 is configured to execute instructions of the graph network engine 340 stored in the memory 204. The graph network engine 340 includes a node generator 410, an edge generator 420 and a graph network constructor 450. It should be understood that the modules 410, 420 and 450 are exemplary and not intended to be limiting. For example, the graph network engine 340 may include a greater or fewer number of modules than that shown. As well, operations described as being performed by a particular module may be additionally or alternatively performed by another subsystem.

In examples, the node generator 410 may receive the set of processed data records 330 (e.g., including corresponding metadata, such as originating attributes 332, hierarchical attributes 334 and/or synthetic attributes 336, among other possibilities) and may generate a plurality of nodes 415. In examples, each node 415 in the plurality of nodes may correspond to a respective processed data record of the set of data records 330. In examples, the nodes 415 may be provided to the edge generator 420 for linking the nodes via edges 425, based on a determined relationship between one or more corresponding processed data records, for example, indicating that the one or more processed data records are likely to represent the same or similar item of the plurality of unique items.

In some embodiments, for example, the nodes 415 may be deterministically linked, for example, using a deterministic linkage engine 430, based on a predetermined criteria or logic, among other possibilities. For example, two or more nodes may be deterministically linked based on a matching of one or more attributes in the corresponding processed data records 330. For example, the nodes may be compared in a pairwise manner, for example, where nodes having a certain number or range of identical fields (e.g., title, description, image, barcode etc.) or a combination of identical fields in their corresponding processed data records, may be deterministically linked (e.g., via an edge 425). In other embodiments, the deterministic linkage engine 430 may link two or more nodes 415 based on an observed indirect relationship between two or more nodes, for example, if node A is linked with node B, and node B is linked with node C, then nodes A and C may also be deterministically linked via an edge 425, based on a common relationship with node B.

In some embodiments, for example, the nodes 415 may be probabilistically linked, for example, using a probabilistic linkage engine 440. For example, two or more nodes may be probabilistically linked via an edge 425 based on a probabilistic likelihood that the linked nodes represent the same item of the plurality of unique items. In some embodiments, for example, the nodes may be evaluated and linked by the probabilistic linkage engine 440 based on a measure of similarity between nodes. By way of example, two nodes having corresponding processed data records may include corresponding metadata comprising a respective image, where the respective images do not represent the exact same image, but may be very similar (e.g., the images show the same item, but were taken at different angles, or in different lighting conditions, or by different cameras having different resolutions etc.). In this regard, the probabilistic linkage engine 440 may link the two nodes via an edge 425, based on the respective images meeting or exceeding a threshold measure of similarity.

In some embodiments, for example, the probabilistic linkage generator 440 may include an embedding generator 442 and a vector similarity search operator 444, among other possibilities. In examples, the embedding generator 442 may receive the plurality of nodes 415 and may generate corresponding node embeddings. In the present disclosure, “embeddings” can refer to learned representations of discrete variables as vectors of numeric values, where the “dimension” of the embedding corresponds to the length of the vector (i.e., each entry in the embedding is a numeric value in a respective dimension represented by the embedding). In some examples, embeddings may be referred to as embedding vectors. In examples, embeddings may represent a mapping between discrete variables and a vector of continuous numbers that effectively capture meaning and/or relationships in the data. In examples, embeddings may be represented as points in a multidimensional space (which may be referred to as the embedding space), where embeddings exhibiting similarity are clustered closer together. In examples, embeddings may be learned for neural network models.

In examples, the embedding generator 442 may apply an embedding transformation to each node in the plurality of nodes 415 to obtain corresponding node embeddings. In examples, the embedding generator 442 may apply the transformation using a neural network model. In some embodiments, for example, the embedding generator 442 may be an encoder. In examples, the embedding generator 442 may encode each node of the plurality of nodes 415 into respective embedding vectors within an embedding space, to generate the node embeddings. In some embodiments, for example, the node embeddings may be stored in an embeddings database 446. In examples, given that each node in the set of nodes 415 corresponds to a respective processed data record of the set of processed data records 330, the embedding transformation may be considered to be applied to the information associated with each node, such as one or more processed data records in the set of processed data records 330, or portions of the processed data records, such as certain fields or images etc., to generate one or more data record embeddings. In the present disclosure, the terms node embeddings and data record embeddings may be used interchangeably.

In examples, the vector similarity search operator 444 may receive the node embeddings (or data record embeddings) and may compare the node embeddings to identify subsets of nodes as candidates for linkage, based on a similarity measure. For example, the vector similarity search operator 354 may search the embedding space defined by the plurality of node embeddings to identify groups (or clusters) of similar node embeddings, based on the similarity measure. In examples, a nearest neighbor approach may be used to identify the groups of similar node embeddings. In examples, the similarity measure may be a distance measure (e.g., a Euclidean distance measured between two node embeddings in any direction within the embedding space), or the similarity measure may be a cosine similarity (e.g., a cosine of the angle between two node embeddings), among other possibilities. In examples, two or more nodes of the plurality of nodes 415 may be probabilistically linked via an edge 425, based on the respective node embeddings meeting or exceeding a threshold measure of similarity, such as a similarity threshold value or a similarity score, among other possibilities.

In examples, the plurality of nodes 415 and edges 425 may be provided to the graph network constructor 450, for example to generate the graph network 350. For example, the graph network constructor 450 may evaluate the nodes of the plurality of nodes 415 that linked by edges 425 and may assemble the graph network 350 according to the determined node linkages, while ensuring that the linked nodes in the graph network 350 effectively correspond to respective data records of the set of data records 310 (and/or respective processed data records of the set of processed data records 330). In some embodiments, for example, the graph network 350 may be stored in a graph database 390, as shown with respect to FIG. 3.

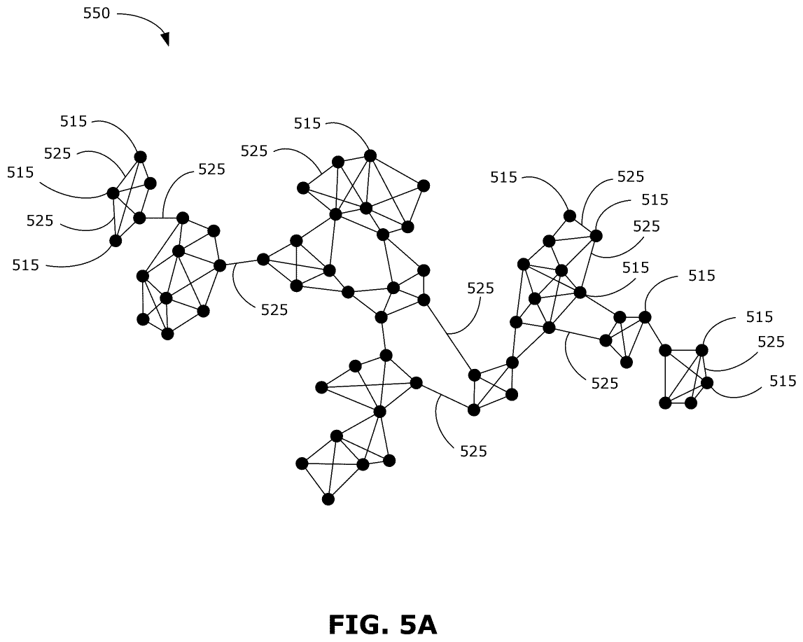

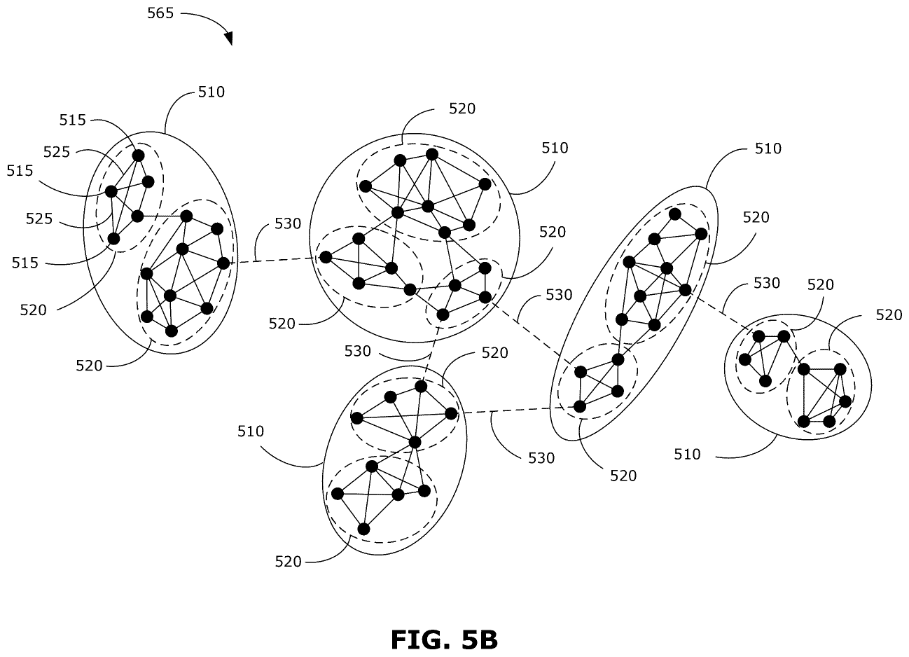

FIG. 5A is a simplified schematic diagram of an example graph network 550, in accordance with examples of the present disclosure. In examples, the graph network 550 may be generated similarly to graph network 350 (as described with respect to FIG. 4), where the graph network 550 is configured as a connected network of nodes 515 and edges 525, for example, where each node 515 represents a corresponding data record and each edge 525 indicates a connection or relationship between the nodes 515. Although the graph network 550 is shown in an example configuration of nodes 515 and edges 525, it should be understood that this example is not intended to be limiting.

Returning to FIG. 3, the graph network 350 may be provided to the clustering engine 360 for generating one or more subsets of nodes in the graph network 350 and for assigning the one or more subsets of nodes to a respective item of the plurality of unique items, among other possibilities. In examples, the clustering engine 360 may cluster the plurality of nodes 415 in the graph network 350, to generate the one or more subsets of nodes, for example, using a clustering algorithm or using probabilistic approaches (such as using a similarity measure), among other possibilities, and may output a clustered graph network 365 incorporating the generated one or more subsets of nodes. In examples, each of the one or more subsets of nodes identified by the clustering engine 360 may represent a group of data records of the set of data records 310 which represent (or which are likely to represent) the same item.

In some examples, the clustering engine 360 may cluster the nodes based on one or more attributes (e.g., where node attributes may be found in a respective data record or processed data record corresponding to the node), among other possibilities. In some embodiments, for example, the clustering engine 360 may apply weights to various attributes associated with each node, for example, for use in a clustering algorithm. In some embodiments, for example, the weights may be determined based on the associated data record category 315 for the node. For example, for nodes associated with a category of “wine”, certain attributes such as year of production (e.g., “vintage”) or “geography” may be more important in differentiating nodes corresponding to different items, whereas for nodes associated with a category of “kitchen appliances”, attributes such as “year of production” or “geography” may be less important in effectively differentiating items.

In some embodiments, for example, the clustering engine 360 may cluster nodes of the graph network 350 according to various levels within a hierarchy of levels, for example, where a top-level may represent a “category” level, and lower levels may represent an “item” level or an “item variant” level, among other possibilities. For example, subsets of nodes generated by the clustering engine 360 according to an “item level”, may be considered to represent the same item. In some examples, further subsets of nodes may be generated by the clustering engine 360, for example, at an “item variant” level, where the further subsets of nodes may be considered to represent the same item variant. For example, an item can have various attributes, where each attribute may include various options, and an item variant may represent a specific combination of the options for a particular item. In an example embodiment, an item can represent a product (e.g., iPhone® 16 Pro Max), where the product can have various attributes (e.g., color, storage size etc.), where options for color may include “black titanium” or “white titanium” etc., or options for storage size may include “256 GB”, “512 GB”, “1 TB” etc., among other possibilities. In examples, for a product such as the iPhone® 16 Pro Max, an item variant may constitute the iPhone® 16 Pro Max in black titanium and having 256 GB storage capacity etc., among other possibilities.

FIG. 5B is a simplified schematic diagram of an example clustered graph network 565, in accordance with examples of the present disclosure. In examples, the clustered graph network 565 may be generated similarly to clustered graph network 365 (as described with respect to FIG. 4), where the clustered graph network 565 is configured as a connected network of nodes 515 and edges 525, and where one or more subsets of nodes have been generated (e.g., by clustering engine 360), where each of the one or more subsets of nodes represents a respective item of the plurality of unique items. For example, the one or more subsets of nodes may be represented in FIG. 5B by primary clusters 510. In examples, each primary cluster 510 may represent groups of nodes (or corresponding data records) which represent (or which are likely to represent) the same item of a plurality of unique items. Although the graph network 500b is shown in an example configuration of nodes 515 and edges 525, 530, it should be understood that this example is not intended to be limiting.

In some embodiments, for example, the edge linking two nodes that are grouped into two separate clusters (e.g., separate primary clusters 510) may be indicated in FIG. 5B as a cross-cluster edge 530. In some embodiments, for example, the cross-cluster edge 530 may be severed during or after clustering, for example, to remove the linkage between nodes that are considered different items, among other possibilities. In other embodiments, for example, cross-cluster edges 530 may represent distant and/or statistically rare linkages between nodes in separate clusters. In some embodiments, for example, nodes that are linked by a cross-cluster edge 530 may include additional metadata, (e.g., related to the current cluster and/or the neighboring cluster associated with the cross-cluster edge 530), for example, to virtually include each of the nodes as a member of both the current cluster for the node, and the neighboring cluster for the node, based on the cross-cluster edge 530, among other possibilities.

In examples, the nodes 515 in each primary cluster 510 may be grouped into further subsets of nodes, for example, represented in FIG. 5B as secondary clusters 520. In examples, where the nodes in each primary cluster 510 may represent the same item, and where the nodes in each secondary cluster 520 may represent the same item variant, among other possibilities.

As shown in FIG. 5B, each primary cluster 510 may include a plurality of secondary clusters 520, where the primary clusters 510 and/or the secondary clusters 520 may be generated by the clustering engine 360, for example, using a clustering algorithm, among other possibilities. Although each primary cluster 510 in FIG. 5B is shown having two or three secondary clusters, it should be understood that this is only exemplary and is not intended to be limiting. Further, this example has been simplified for ease of understanding.

Returning to FIG. 3, responsive to the generation by the clustering engine 360 of the one or more subsets of nodes in the clustered graph network 365, an item identifier (e.g., a UID associated with the item) may be assigned to each of the one or more the subsets of nodes in the clustered graph network 365, or to each node of a particular subset of nodes in the clustered graph network 365, for example, to associate the subset of nodes with the item. In some embodiments, for example, each node in a particular subset of nodes in the clustered graph network 365 may be annotated with the associated item identifier (e.g., UID), or in other embodiments, for example, the UID may appended to the corresponding data records of the set of data records 310 (e.g., stored in the data store 130) that are associated with a particular subset of nodes in the graph network 350.

In examples, the clustered graph network 365 (e.g., including the identified one or more subsets of nodes and/or assigned UIDs associated with each of the one or more subsets of nodes, among other information) may be provided to the verification engine 370, for example, for verifying that the one or more subsets of nodes in the clustered graph network 365 are correctly assigned to the respective item of the plurality of unique items. In examples, the verification engine 370 may cooperate with LLM 150 to perform the verification, for example, a selection of node pairs (e.g., randomly selected pairs of linked nodes) that are associated with the same subset of nodes (e.g., primary cluster) in the clustered graph network 365 may be input to LLM 150 in a verification step. For example, the verification engine 370 may include a prompt generator (not shown) for generating a prompt to the LLM 150, or a prompt generator external to the record deduplication system 300 may be utilized, among other possibilities. In some embodiments, for example, the LLM 150 may be a multi-modal LLM (e.g., LLaVA, BLIP-2, CLIP, GPT-4V, etc.).

In examples, the prompt may be provided to the LLM 150 to instruct the LLM to compare a pair of nodes (e.g., a pair of nodes associated with the same subset of nodes of the one or more subsets of nodes) and to determine whether the pair of nodes does in fact represent the same item. In some examples, the LLM 150 may be trained or otherwise instructed to consider variants of an item to be the same item. In examples, the prompt provided to the LLM 150 may include attributes and/or images associated with the pair of nodes (among other information), and instructions to generate a response indicating whether the pair of nodes represents the same item, based on the provided attributes and/or images (or other information) associated with the pair of nodes, among other possibilities. In some embodiments, for example, the LLM 150 may be instructed to output a numerical representation (e.g., a confidence level or a similarity score etc.) with the response, for example, for indicating a likelihood that the pair of nodes represents the same item. In other embodiments, for example, a ground-truth dataset of node pairs that should/should not be linked may be provided in a prompt to the LLM 150, for instructing the LLM 150 to verify the accuracy of the generated graph network, based on the ground-truth dataset, among other possibilities. In this regard, presenting targeted data to the LLM for verification helps reduce unnecessary computation associated with complete pairwise evaluation of all data records using the LLM.

In examples, the response generated by the LLM 150 may inform further updates to the graph network 350 or the clustered graph network 365, for example, the verification engine 370 may receive the response from the LLM 150 indicating whether the pair of nodes represents the same item and may further update the graph network 350 or the clustered graph network 365 based on the verification. For example, the verification engine 370 may communicate with the clustering engine 360 and/or the graph network generator to 340 to modify at least one node in the graph network 350 or the clustered graph network 365 based on a determination of whether the at least one node is correctly assigned to the respective item of the plurality of unique items.

In some examples, if the LLM 150 outputs a response that indicates that the node pair represents the same item, then actions may be taken to merge the data records associated with the node pair or otherwise deduplicate the data records associated with the graph network. For example, the verification engine 370 may indicate that a node associated with a first subset of the one or more subsets of nodes should be merged with another node in the first subset of nodes or removed from the first subset of nodes, among other possibilities.

In other examples, if the LLM 150 outputs a response that indicates that the node pair does not represent the same item, then actions may be taken to remove linkages associated with the node pair (or with other nodes in the same subset of nodes) or update subsets of nodes according to the verified (or invalidated) linkages between nodes. For example, the verification engine 370 may communicate with the clustering engine 360 that a node associated with the node pair should be moved and/or added to a second subset of nodes that is different from the first subset of nodes, among other possibilities. By way of an example scenario, nodes A, B and C may all be linked with each other within a subset of nodes (e.g., Cluster 1). For example, suppose nodes A+B and B+C were linked during construction of the graph network 350 based on output from the probabilistic linkage engine 440 (e.g., based on similarity scores as described above with respect to FIG. 4, among other possibilities), and nodes A+C were linked indirectly based on their common node B. However, in the present example, it is determined by the LLM 150 that nodes A and B do not represent the same item and were erroneously linked. In this case, the record deduplication system 300 may be configured to remove the linkage between nodes A+B, as well as between nodes A+C in the graph network 350. For example, the verification engine 370 may communicate with the graph network engine 340 to further update the graph network 350 by removing the linkages between nodes A+B and between A+C. In examples, the clustering engine 360 may regenerate the clustered graph network 365, for example, by regenerating the one or more subsets of nodes (e.g., such that node A is no longer in the same cluster as nodes B+C) or by reassigning the one or more subsets of nodes to a respective item of the plurality of unique items. In examples, the record deduplication system 300 may also store information in the data records associated with nodes A and B that may permanently block future links between nodes A and B, among other possibilities. For example, linkage rules or other logic may be stored, for example, in the graph database 390 and may be accessible to the graph network engine 340 and/or to the clustering engine 360 for informing future updates to the graph network 350 or future updates to the generated subsets of nodes in the updated graph network 365, among other possibilities.

In other examples, common or otherwise universal attributes associated with the nodes in a certain subset of nodes (e.g., a first subset) may be identified and applied to all nodes within the first subset. For example, data records associated with nodes clustered in the first subset of nodes that are found to be missing entries in data fields that are found to be populated in other data records associated with neighboring nodes (e.g., also in the first subset) may be updated to include the missing information. In this regard, the verification engine 370 may communicate with the graph network engine 340 to update data records for a node associated with the first subset of nodes (e.g., stored in the graph database 390, among other possibilities), for example, to include information common to other nodes in the first subset, among other possibilities.

In examples, responsive to updating the graph network 350 (and optionally, re-clustering the nodes in the clustered graph network 365), the verification engine 370 may output a set of deduplicated data records 380, for example, based on the updated graph network. In some embodiments, for example, the deduplicated data records 380 may be provided to the data store 130, for example, for updating and/or replacing corresponding data records (e.g., the set of data records 310) in the data store 130, among other possibilities.

Optionally, the record deduplication system 300 may cooperate with a UI to display elements based on the clustered graph network 365. For example, a search engine tasked with searching a database (such as the data store 130 storing the set of data records 310, among other possibilities) may return search results that reflect the linkages and/or clusters captured by the graph network 350 and/or the clustered graph network 365, for example, based on the associated item identifier (e.g., UID) for each data record in the database. In some embodiments, for example, the search engine may retrieve a set of results, for example, responsive to a user query.

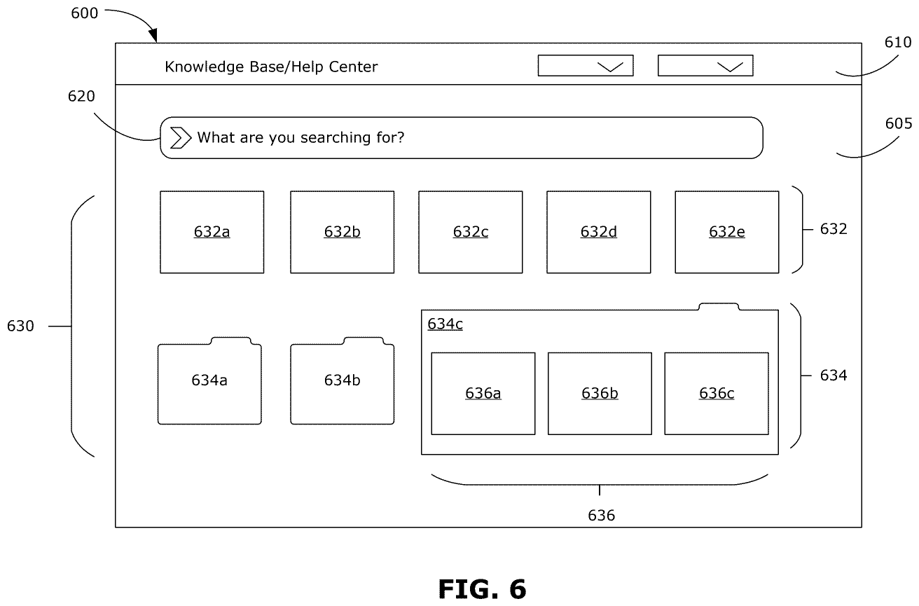

FIG. 6 illustrates an example of a simplified graphical user interface (GUI) 600, in accordance with examples of the present disclosure. In the example of FIG. 6, the GUI 600 is implemented via a web page, such as a search engine UI or another web-based UI (e.g., a web-based knowledge base or help center, among other possibilities) that has multiple pages or tabs, as indicated in the navigation bar 610, although other use cases may be applicable. It should be understood that this example is not intended to be limiting.

In this simple example, a user may provide an input to an input portion 620 in the form of a search query (e.g., user query 305) and may view and/or navigate through a plurality of search results 630 that are returned in the search UI 605 responsive to a search query. For example, a user may provide input to the input portion 620 as a text input (e.g., received via a keyboard of computing system 200) or the user may provide input by other means, such as audio input (e.g., received via a microphone of computing system 200), or as a touch input, among other possibilities. In examples, a search engine associated with the search UI may search a database (e.g., data store 130) and retrieve a plurality of search results 630 for a plurality of unique items, based on information stored in the data store 130. For example, the search engine may return search results 630 based on unique identifiers (e.g., UIDs generated by the record deduplication system 300 and appended to data records in the data store 130 that are associated with particular subsets of nodes in the clustered graph network 365 and/or the graph database 390), among other possibilities. In other embodiments, the search engine may interface with the record deduplication system 300 to search the graph database 390 directly, among other possibilities.

In some embodiments, for example, the GUI 600 may include a search UI 605 including a plurality of GUI elements (e.g., search results) that may be automatically configured within the GUI 600. For example, the search results 630 may include individual search results 632, for example, associated with a unique item 632a or 632b, among other possibilities. In examples, the UI may return search results 630 in a condensed configuration, where returned results that are determined to represent the same item (e.g., based on the corresponding UID) may be grouped or collapsed into a single selectable object (e.g., a selectable container object 634) in the search UI 605, for example, to enable viewing a greater variety of search results 630 in the search UI 605. In this regard, the system may cooperate with the GUI 600 to automatically organize GUI elements within the GUI 600 according to a need of the user or the system, among other possibilities. In examples, the selectable container object 634 may include a visual indicator that indicates that the object 634 contains a subset of duplicate items (e.g., search results representing the same item from different sources (e.g., data sources 140), among other possibilities) that have been grouped together. In the example of FIG. 6, the visual indicator is presented in the form of a folder icon, however it us understood that any indicator may be used.

In some embodiments, for example, the object 634 may be presented in a collapsed form (e.g., collapsed object 634a) or in an expanded form (e.g., expanded object 634b). In examples, selecting the collapsed object 364a in the search UI 605 may expand the object to enable viewing of all of the returned search results in the group (e.g., a subset of search results 636), where each individual search result 636a, 636b, 636c etc. of the subset of search results 636 may represent a specific variation of a unique item or entity. Similarly, selecting the expanded object 634b in the search UI 605 may collapse the object to hide the subset of search results 636, and enable a greater variety of search results to be displayed. In this regard, providing a user with the ability to collapse collections of multiple returned search results representing the same item into one selectable object enables the viewing of greater item diversity and/or variety within the UI and further reduces the unnecessary processing associated with rendering duplicates of the search results.

In other embodiments, for example, the record deduplication system 300 may interface with a search UI or another web-based UI via the UI module 395, to facilitate outputting the plurality of returned search results to a display of a user device based on the clustered graph network 365 or based on data records stored in the graph database 390, among other possibilities. For example, the record deduplication system 300 may optionally be used for pooling cluster-based information for input to LLM 150 for answering questions about specific items represented by nodes in one or more subsets of nodes of the graph network, for inclusion with the search results 630, among other possibilities. For example, a user may provide an input to the input portion 620 in the form of a question about a specific item, such as “how many colours are available for the iPhone® 16 Pro Max?”. In examples, the search UI may interface with the record deduplication system 300 to generate a prompt to LLM 150 instructing the LLM 150 to draw from cluster-based information stored in graph database 390 to generate a response that answers the user's question. In this regard, augmenting the LLM 150 with relevant and readily available cluster-based information may improve computational efficiency associated with otherwise computationally expensive LLM-based response generation.

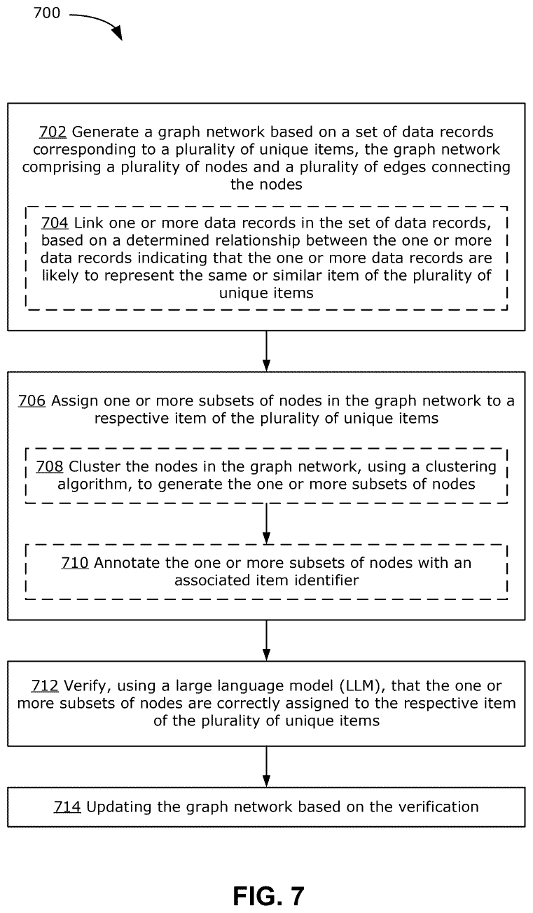

FIG. 7 is a flowchart of an example method 700 for deduplicating data records 310, in accordance with examples of the present disclosure. The method 700 may be performed by the computing system 200. For example, a processing unit of a computing system (e.g., the processor 202 of the computing system 200 of FIG. 2B) may execute instructions (e.g., instructions of the record deduplication system 300) to cause the computing system to carry out the example method 700. The method 700 may, for example, be implemented by an online platform or a server.

At an operation 702, a graph network 350 may be generated, based on a set of data records 310 (or a set of processed data records 320) corresponding to a plurality of unique items. In examples, the graph network 350 comprises a plurality of nodes 415 and a plurality of edges 425 connecting the nodes 415, wherein each node 415 in the graph network 350 corresponds to a respective data record of the set of data records 310 (or the set of processed data records 320) and each edge 425 in the graph network 350 represents a relationship between two associated nodes, the nodes being connected by the edge. In examples, in generating the graph network 350, operation 704 may be performed.

At an operation 704, one or more data records in the set of data records 310 (or in the set of processed data records 320) may be linked (e.g., by an edge 425) based on a determined relationship between the one or more data records indicating that the one or more data records are likely to represent the same or similar item of the plurality of unique items. In examples, the determined relationship may further be based on a deterministic matching of attributes in the processed data records or based on a probabilistic likelihood that the linked data records represent the same item of the plurality of unique items, among other possibilities.

At an operation 706, one or more subsets of nodes in the graph network 350 may be assigned to a respective item of the plurality of unique items. In examples, in assigning the one or more subsets of nodes in the graph network 350, operations 708-710 may be performed.

At an operation 708, the one or more subsets of nodes may be generated by clustering the nodes 415 in the graph network 350, for example, using a clustering algorithm. For example, the nodes 415 in the graph network 350 may be clustered based on one or more attributes of a data record associated with the node or based on an associated data record category 315 for the node, among other possibilities. At an operation 710, the one or more subsets of nodes may be annotated with an associated item identifier, such as a UID associated with the item.

At an operation 712, the LLM 150 may be used to verify that the one or more subsets of nodes are correctly assigned to the respective item of the plurality of unique items. For example, a prompt may be provided to the LLM instructing the LLM to output a response indicating whether the pair of nodes represents the same item.

At an operation 714, the graph network may be updated based on the verification. For example, responsive to the verification, at least one node in the graph network 350 (or the clustered graph network 365) may be modified, based on a determination of whether the at least one node is correctly assigned to the respective item of the plurality of unique items. In examples, the modification may include merging the at least one node with another node in the first subset of nodes, updating the at least one node to include information common to other nodes in the first subset of nodes, removing the at least one node from the first subset of nodes or adding the at least one node to a second subset of nodes that is different from the first subset of nodes, among other possibilities.

Although the present disclosure has described a LLM in various examples, it should be understood that the LLM may be any suitable language model (e.g., including LLMs such as LLaMA, Falcon 40B, GPT-3, GPT-4 or ChatGPT, as well as other language models such as BART, among others).

Although the present disclosure describes methods and processes with operations (e.g., steps) in a certain order, one or more operations of the methods and processes may be omitted or altered as appropriate. One or more operations may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
generating a graph network based on a set of data records corresponding to a plurality of unique items, the graph network comprising a plurality of nodes and a plurality of edges connecting the nodes, wherein each node in the graph network corresponds to a respective data record of the set of data records and each edge in the graph network represents a relationship between two associated nodes, the nodes being connected by the edge;
assigning one or more subsets of nodes in the graph network to a respective item of the plurality of unique items;
verifying, using a large language model (LLM), that the one or more subsets of nodes are correctly assigned to the respective item of the plurality of unique items; and
updating the graph network based on the verification.

2. The method of claim 1, wherein assigning the one or more subsets of nodes in the graph network to the respective item comprises:
clustering the nodes in the graph network, using a clustering algorithm, to generate the one or more subsets of nodes; and
annotating the one or more subsets of nodes with an associated item identifier.

3. The method of claim 1, further comprising:
processing the set of data records to generate a set of processed data records including corresponding metadata; and
generating the graph network based on the set of processed data records.

4. The method of claim 3, wherein each data record in the set of data records is associated with a respective category, and processing the set of data records comprises:
for each data record in the set of data records:
generating the metadata as one or more attributes, based on the respective category; and
appending the one or more attributes to the data record to generate a processed data record.

5. The method of claim 4, wherein the one or more attributes are synthetic attributes generated using a multi-modal LLM.

6. The method of claim 4, wherein the data record includes an image, and the one or more attributes are generated based on the image.

7. The method of claim 1, wherein generating the graph network comprises:
linking one or more data records in the set of data records, based on a determined relationship between the one or more data records indicating that the one or more data records are likely to represent the same or similar item of the plurality of unique items.

8. The method of claim 7, wherein the determined relationship is based on a deterministic matching of attributes in the processed data records.

9. The method of claim 7, wherein the determined relationship is based on a probabilistic likelihood that the linked data records represent the same item of the plurality of unique items.

10. The method of claim 1, wherein generating the graph network comprises:
applying an embedding transformation to one or more data records in the set of data records, to generate one or more data record embeddings; and
linking at least two of the data records, based on a similarity measure between corresponding at least two of the data record embeddings;
wherein each node corresponds to a respective data record of the linked data records and each edge corresponds to a respective relationship between two of the linked data records.

11. The method of claim 1, wherein verifying that the one or more subsets of nodes are correctly associated with the respective item comprises:
generating a prompt to the LLM for comparing a pair of nodes of the one or more subsets of nodes, the prompt including attributes and/or images associated with the pair of nodes and instructions to determine whether the pair of nodes represent the same item; and
providing the prompt to the LLM to generate a response indicating whether the pair of nodes represent the same item.

12. The method of claim 1, wherein updating the graph network comprises:
modifying at least one node in the graph network, based on a determination of whether the at least one node is correctly assigned to the respective item of the plurality of unique items.

13. The method of claim 12, wherein the at least one node is associated with a first subset of the one or more subsets of nodes in the graph network, and modifying the at least one node comprises one of:
merging the at least one node with another node in the first subset of nodes;
updating the at least one node to include information common to other nodes in the first subset of nodes;
removing the at least one node from the first subset of nodes; or
adding the at least one node to a second subset of nodes that is different from the first subset of nodes.

14. The method of claim 1, further comprising:
responsive to a search query, transmitting a signal to cause a display of a remote user device to output a user interface (UI) having a plurality of returned search results corresponding to the plurality of unique items, based on the updated graph network.

15. A computer system comprising:
a processing unit configured to execute computer-readable instructions to cause the system to:
generate a graph network based on a set of data records corresponding to a plurality of unique items, the graph network comprising a plurality of nodes and a plurality of edges connecting the nodes, wherein each node in the graph network corresponds to a respective data record of the set of data records and each edge in the graph network represents a relationship between two associated nodes, the nodes being connected by the edge;
assign one or more subsets of nodes in the graph network to a respective item of the plurality of unique items;
verify, using a large language model (LLM), that the one or more subsets of nodes are correctly assigned to the respective item of the plurality of unique items; and
update the graph network based on the verification.

16. The system of claim 15, wherein in assigning the one or more subsets of nodes in the graph network to the respective item, the processing unit is further configured to execute computer-readable instructions to cause the computer system to:
cluster the nodes in the graph network, using a clustering algorithm, to generate the one or more subsets of nodes; and
annotate the one or more subsets of nodes with an associated item identifier.

17. The system of claim 15, wherein each data record in the set of data records is associated with a respective category, and wherein the processing unit is further configured to execute computer-readable instructions to cause the computer system to:
process the set of data records to generate a set of processed data records including corresponding metadata by:
for each data record in the set of data records:
generating the metadata as one or more attributes, based on the respective category; and
appending the one or more attributes to the data record to generate a processed data record; and
generate the graph network based on the set of processed data records.

18. The system of claim 15, wherein in generating the graph network, the processing unit is further configured to execute computer-readable instructions to cause the computer system to:
link one or more data records in the set of data records, based on a determined relationship between the one or more data records indicating that the one or more data records are likely to represent the same or similar item of the plurality of unique items.

19. The system of claim 15, wherein in verifying that the one or more subsets of nodes are correctly associated with the respective item, the processing unit is further configured to execute computer-readable instructions to cause the computer system to:
generate a prompt to the LLM for comparing a pair of nodes of the one or more subsets of nodes, the prompt including attributes and/or images associated with the pair of nodes and instructions to determine whether the pair of nodes represent the same item; and
provide the prompt to the LLM to generate a response indicating whether the pair of nodes represent the same item.

20. A non-transitory computer-readable medium storing instructions that, when executed by a processor of a computing system, cause the computing system to:
generate a graph network based on a set of data records corresponding to a plurality of unique items, the graph network comprising a plurality of nodes and a plurality of edges connecting the nodes, wherein each node in the graph network corresponds to a respective data record of the set of data records and each edge in the graph network represents a relationship between two associated nodes, the nodes being connected by the edge;
assign one or more subsets of nodes in the graph network to a respective item of the plurality of unique items;
verify, using a large language model (LLM), that the one or more subsets of nodes are correctly assigned to the respective item of the plurality of unique items; and
update the graph network based on the verification.
